(19) United States
(12) Patent Application Publication
(10) Pub. No.: US 2007/0223680 A1
(43) Pub. Date: Sep. 27, 2007

(54) System to Regulate Aspects of an Environment with a Limited Number of Service Stations

(76) Inventor: Jeffrey Schox, San Francisco, CA (US)

Correspondence Address: SCHOX PLC, 209 N. MAIN STREET #200, ANN ARBOR, MI, 48104, US

(21) Appl. No.: 11/690,123

(22) Filed: Mar. 22, 2007

Related U.S. Application Data
(60) Provisional application No. 60/785,033, filed on Mar. 22, 2006.

(51) Int. Cl. H04M 7/00

(52) U.S. Cl. 379/221.07

(57) ABSTRACT

A system to automatically adjust an aspect of an environment with a limited number of service stations usable by customers. The system includes a sensor to provide a measurement based the present or expected the number of service stations used by a customer; a processor to determine a value representing the present or expected load on the limited number of service stations currently and to determine the appropriate change in the environment; and a regulator that adjusts an aspect of the environment to adjust the behavior of the customers in the environment. The system has been specifically designed to be incorporated into an environment with a limited number of service stations. As an example, the system may be incorporated in an establishment (such as a café, bar, or restaurant) with a limited number of seating spaces.

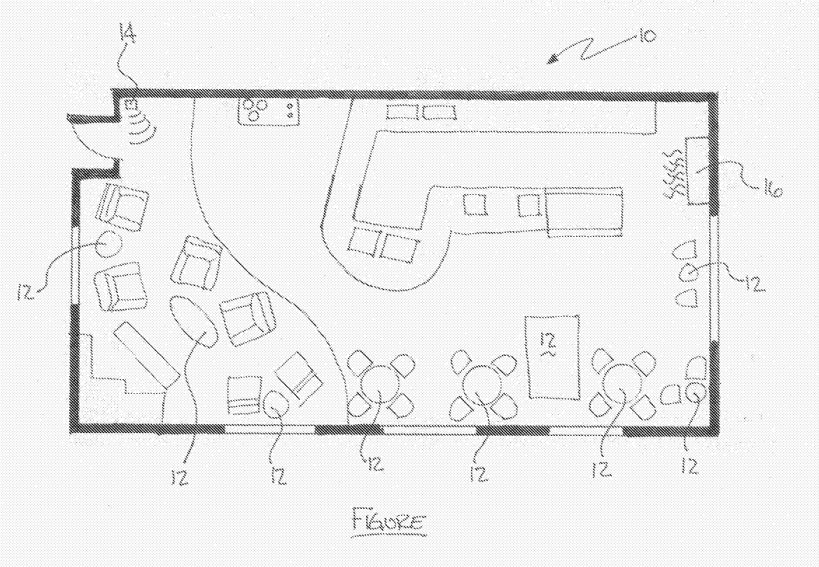

### CROSS-REFERENCE TO RELATED APPLICATIONS

This application claims the benefit of U.S. Provisional Application No. 60/785,033 entitled “System to Regulate Aspects of an Environment with Service Stations” and filed 22 Mar. 2006, which is incorporated in its entirety by this reference.

### BRIEF DESCRIPTION OF THE FIGURE

The FIGURE is a schematic representation of the system of the preferred embodiment in a suitable environment.

### DESCRIPTION OF THE PREFERRED EMBODIMENT

The following description of the preferred embodiment of the invention is not intended to limit the invention to this preferred embodiment, but rather to enable any person skilled in the art to make and use this invention.

As shown in the FIGURE, the system of the preferred embodiment functions to automatically adjust an aspect of an environment 10 with a limited number of service stations 12. The system of the preferred embodiment includes (a) a sensor 14 to provide a measurement or estimate of the service stations 12 currently, or soon to be, used; (b) a processor to determine the fraction of the limited number of service stations 12 currently, or soon to be, used and to determine the appropriate change in the environment 10; and (c) a regulator 16 to adjust the environment 10, which—in a suggestive manner—adjusts the behavior of the customers. The system has been specifically designed to be incorporated into an environment with a limited number of service stations. As an example, the system may be incorporated in an establishment (such as a café, bar, or restaurant) with a limited number of seating spaces.

The system of the preferred embodiment may also be incorporated in an establishment (such as a store) with a limited number of sampling stations (such as dressing rooms, listening stations, or viewing booths). In these environments with a limited number of service stations 12, the primary objective is to sell an item (such as a coffee drink or a pair of jeans), while the secondary objective is to provide a service station 12 that promotes a relaxed enjoyment, experience, or inspection of the item. The relaxed state of the customer in the service station 12 hopefully promotes the sale, or future sale, of the item. When all of the service stations 12 are occupied or used, however, it may be more profitable to provide a service station that promotes a stimulated enjoyment, experience, or inspection of the item. The stimulated state of the customer in the service station hopefully still promotes the sale, or future sale, of the item while quickly turning over the service station 12 to the next customer. With this system, the establishment may be able to maximize profits by providing the right balance of customer enjoyment and experience and service station turn over.

The sensor 14 of a first version of the preferred embodiment functions to provide a measurement or estimate of the number of service stations 12 currently used. In a first variation, the service stations 12 include pressure sensors or “use” sensors that indicate whether a service station 12 (such as a seat in a coffee shop) is being used. In another variation, the service stations 12 include RFID tags on a suitable item (such as a mug, plate, hanger, or clothing item) and an antenna to measure or estimate the location of the tagged items and indicate whether a service station 12 is being used. In yet another variation, the sensor 14 may include a reservation device that allows future users to sign-up for a service station 12. The reservation device may be mechanical (such as a punch card), may be electrical (such as a webpage form, a telephone system, a SMS system, or an email account), or may be any other suitable device or method that allows reservations. The sensor may, however, include any suitable device or method to provide a measurement or estimate of the number of service stations currently used.

The sensor 14 of a second version of the preferred embodiment functions to provide a measurement or estimate of the number of service stations 12 soon to be used. In a first variation, the sensor 14 measures the number of customers entering and/or exiting an environment 10. The sensor 14 may include a motion detector or any other suitable detector to measure the number of customers entering and/or exiting an environment 10. In a second variation, the sensor 14 measures the number of customers waiting in line for a service station 12. The sensor 14 may include a pressure sensor, a thermal detector or any other suitable detector to measure the number of customers waiting in line for a service station 12. In a third variation, the sensor 14 measures the number and/or frequency of customers who have recently placed an order (such as a food or drink order). The sensor 14 preferably includes an application that receives information from a cashier machine, but may include any suitable device or method to measure the number of customers who have recently placed an order. The sensor may, however, include any suitable device or method to provide a measurement or estimate of the number of service stations soon to be used.

The processor of the preferred embodiment functions to determine the fraction of the limited number of service stations 12 currently, or soon to be, used and to determine the appropriate change in the environment 10. The processor preferably allows an input from a user of the value representative of the total number of service stations 12. The processor also preferably allows an input of the algorithm parameters that determine the appropriate change in the environment 10. The processor is preferably a typical microprocessor, but may include any suitable device or method, including a processor in a remote location over a network connection. The appropriate change in the environment 10 preferably includes a change from a relaxed state to a stimulated state when the fraction of the limited number of service stations 12 increases above a threshold, and a change from a stimulated state to a relaxed state when the fraction of the limited number of service stations 12 falls under a threshold. The appropriate change may, however, include any suitable methodology, including a learning or adaptive methodology commonly found in artificial intelligence applications.

The regulator 16 of the preferred embodiment functions to adjust the environment 10, which—in a suggestive manner—adjusts the behavior of the customers. The regulator 16 preferably adjusts one or more of the following aspects of the environment 10: (1) intensity of the light; (2) subject matter or intensity of an image on a screen or a projection; (3) intensity or quality of the smell; (4) intensity of the music or sound; and (5) temperature of the air. The intensity of the light may be adjusted through the luminosity of artificial light, or the filtering/blocking of natural light. The subject matter or intensity of an image may be adjusted through the selection of a different image file or a different image effect that is displayed on a screen or projected onto a wall. The intensity or quality of smell may be adjusted through the introduction of neutralizing agents (such as ozone) or positive agents (such as essential oils). The intensity of the music or sound may be adjusted by changing the volume or pitch of the songs or the selection of songs with different beats-per-minute (bpm), tempo, tone, or other suitable parameter that describes the intensity of music or sound. The temperature of the air may be adjusted by introducing cool or hot air into the environment 10. The regulator may alternatively adjust any other suitable aspect of the environment that attempts to shift the user experience from a relaxed state to a stimulated state.

As a person skilled in the art will recognize from the previous detailed description and from the figures and claims, modifications and changes can be made to the preferred embodiment of the invention without departing from the scope of this invention defined in the following claims.

I claim:

1. A system to automatically adjust an aspect of an environment with a limited number of service stations usable by customers, comprising:
a sensor to provide a measurement based the present or expected the number of service stations used by a customer;
a processor to determine a value representing the present or expected load on the limited number of service stations currently and to determine the appropriate change in the environment; and
a regulator that adjusts an aspect of the environment to adjust the behavior of the customers in the environment.

2. The system of claim 1 wherein the sensor is adapted to provide a measurement of the number of service stations presently used by a customer.

3. The system of claim 2 wherein the sensor includes a pressure sensor that indicates whether a service station is being used.

4. The system of claim 2 wherein the sensor includes an RFID tag on a item of the environment and an antenna that measures the location of the tagged items and indicates whether a service station is being used.

5. The system of claim 4 wherein the RFID tag is on an item selected from the group consisting of mug, plate, hanger, and clothing item.

6. The system of claim 1 wherein the sensor is adapted to provide a measurement of the number of service stations expected to be used by a customer.

7. The system of claim 6 wherein the sensor measures the number of customers entering the environment.

8. The system of claim 6 wherein the sensor measures the number of customers waiting for a service station.

9. The system of claim 6 wherein the sensor measures the number of customers who place an order.

10. The system of claim 9 wherein the sensor includes a connection to a cashier machine.

11. The system of claim 6 wherein the sensor measures the frequency of customers who place an order.

12. The system of claim 11 wherein the sensor includes a connection to a cashier machine.

13. The system of claim 1 wherein the adjustment in the environment includes a change from a relaxed state to a stimulated state when the fraction of the limited number of service stations increases above a threshold, and a change from a stimulated state to a relaxed state when the fraction of the limited number of service stations falls under a threshold.

14. The system of claim 1 wherein the regulator adjusts one or more of the aspects of the environment selected from the group consisting of: (1) intensity of the light; (2) subject matter or intensity of an image on a screen or a projection; (3) intensity or quality of the smell; (4) intensity of the music or sound; and (5) temperature of the air.

15. The system of claim 1 wherein the regulator adjusts the luminosity of artificial light.

16. The system of claim 1 wherein the regulator adjusts the volume of the music in the environment.

17. The system of claim 1 wherein the regulator adjusts the beats-per-minute of the music in the environment.

18. The system of claim 1 further comprising a limited number of service stations.

19. The system of claim 18 wherein the service stations include a table and a chair.

20. The system of claim 18 wherein the service stations include a dressing room.
